(19) United States
(12) Patent Application Publication
(10) Pub. No.: US 2009/0200038 A1
(43) Pub. Date: Aug. 13, 2009

(54) HYDRAULIC CONNECTOR APPARATUSES AND METHODS OF USE WITH DOWNHOLE TUBULARS

(75) Inventors: George Swietlik, Lowestoft (GB); Burney J. Latiolais, JR., Lafayette, LA (US)

Correspondence Address: OSHA LIANG LLP - Frank''s International, TWO HOUSTON CENTER, 909 FANNIN STREET, SUITE 3500, Houston, TX, 77010, US

(73) Assignee: Pilot Drilling Control Limited, Lowestoft (GB)

(21) Appl. No.: 12/368,161

(22) Filed: Feb. 9, 2009

Related U.S. Application Data
(63) Continuation-in-part of application No. 11/703,915, filed on Feb. 8, 2007.

(30) Foreign Application Priority Data
Feb. 8, 2006 (GB) 0602565.4
Feb. 8, 2008 (GB) 0802406.9
Feb. 8, 2008 (GB) 0802407.7
Mar. 20, 2008 (GB) 0805299.5

(51) Int. Cl. E21B 21/10; E21B 21/00; E21B 34/00; E21B 33/02; F16L 37/04

(52) U.S. Cl. 166/373; 175/218; 285/33

(57) ABSTRACT

A hydraulic connector to direct fluids between a lifting assembly and a bore of a downhole tubular includes an engagement assembly configured to selectively extend and retract a seal assembly disposed at a distal end of the hydraulic connector into and from a proximal end of the downhole tubular and a valve assembly operable between an open position and a closed position, wherein the valve assembly is configured to allow the fluids to communicate between the lifting assembly and the downhole tubular through the seal assembly when in the open position, and wherein the valve assembly is configured to prevent fluid communication between the lifting assembly and the downhole tubular when closed position, and a one-way valve to allow fluid communication from the downhole tubular to the lifting assembly.

### CROSS-REFERENCE TO RELATED APPLICATIONS

The present application claims benefit under 35 U.S.C. § 120, as a Continuation-In-Part, to U.S. patent application Ser. No. 11/703,915, filed Feb. 8, 2007, which, in-turn, claims priority to United Kingdom Patent Application No. 0602565.4 filed Feb. 8, 2006. Additionally, the present application claims priority to United Kingdom Patent Application No. 0802406.9 and United Kingdom Patent Application No. 0802407.7, both filed on Feb. 8, 2008. Furthermore, the present application claims priority to United Kingdom Patent Application No. 0805299.5 filed Mar. 20, 2008. All priority applications and the co-pending U.S. parent application are hereby expressly incorporated by reference in their entirety.

### BACKGROUND OF THE DISCLOSURE

1. Field of the Disclosure

The present disclosure generally relates to a connector establishing a fluid-tight connection to a downhole tubular. More particularly, the present disclosure relates to a connector establishing a fluid-tight connection between a downhole tubular and a lifting assembly. Alternatively, the present disclosure relates to a connector establishing a fluid-tight connection between a downhole tubular and another tubular.

2. Description of the Related Art

It is known in the industry to use a top-drive assembly to apply rotational torque to a series of inter-connected tubulars (commonly referred to as a drillstring comprised of drill pipe) to drill subterranean and subsea oil and gas wells. In other operations, a top-drive assembly may be used to install casing strings to already drilled wellbores. The top-drive assembly may include a motor, either hydraulic, electric, or other, to provide the torque to rotate the drillstring, which in turn rotates a drill bit at the bottom of the well.

Typically, the drillstring comprises a series of threadably-connected tubulars (drill pipes) of varying length, typically about 30 ft (9.14 m) in length. Typically, each section, or “joint” of drill pipe includes a male-type “pin” threaded connection at a first end and a corresponding female-type “box” threaded connection at the second end. As such, when making-up a connection between two joints of drill pipe, a pin connection of the upper piece of drill pipe (i.e., the new joint of drill pipe) is aligned with, threaded, and torqued within a box connection of a lower piece of drill pipe (i.e., the former joint of drill pipe). In a top-drive system, the top-drive motor may also be attached to the top joint of the drillstring via a threaded connection.

During drilling operations, a substance commonly referred to as drilling mud is pumped through the connection between the top-drive and the drillstring. The drilling mud travels through a bore of the drillstring and exits through nozzles or ports of the drill bit or other drilling tools downhole. The drilling mud performs various functions, including, but not limited to, lubricating and cooling the cutting surfaces of the drill bit. Additionally, as the drilling mud returns to the surface through the annular space formed between the outer diameter of the drillstring and the inner diameter of the borehole, the mud carries cuttings away from the bottom of the hole to the surface. Once at the surface, the drill cuttings are filtered out from the drilling mud and the drilling mud may be reused and the cuttings examined to determine geological properties of the borehole.

Additionally, the drilling mud is useful in maintaining a desired amount of head pressure upon the downhole formation. As the specific gravity of the drilling mud may be varied, an appropriate “weight” may be used to maintain balance in the subterranean formation. If the mud weight is too low, formation pressure may push back on the column of mud and result in a blow out at the surface. However, if the mud weight is too high, the excess pressure downhole may fracture the formation and cause the mud to invade the formation, resulting in damage to the formation and loss of drilling mud.

As such, there are times (e.g., to replace a drill bit) where it is necessary to remove (i.e., “trip out”) the drillstring from the well and it becomes necessary to pump additional drilling mud (or increase the supply pressure) through the drillstring to displace and support the volume of the drillstring retreating from the wellbore to maintain the well's hydraulic balance. By pumping additional fluids as the drillstring is tripped out of the hole, a localized region of low pressure near or below the retreating drill bit and drill pipe (i.e., suction) may be reduced and any force required to remove the drillstring may be minimized. In a conventional arrangement, the excess supply drilling mud may be pumped through the same connection, between the top-drive and drillstring, as used when drilling.

As the drillstring is removed from the well, successive sections of the retrieved drillstring are disconnected from the remaining drillstring (and the top-drive assembly) and stored for use when the drillstring is tripped back into the wellbore. Following the removal of each joint (or series of joints) from the drillstring, a new connection must be established between the top-drive and the remaining drillstring. However, breaking and re-making these threaded connections, two for every section of drillstring removed, is very time consuming and may slow down the process of tripping out the drillstring.

Previous attempts have been made at speeding up the process of tripping-out. GB2156402A discloses methods for controlling the rate of withdrawal and the drilling mud pressure to maximize the speed of tripping-out the drillstring. However, the amount of time spent connecting and disconnecting each section of the drillstring to and from the top-drive is not addressed.

Another mechanism by which the tripping out process may be sped up is to remove several joints at a time (e.g., remove several joints together as a “stand”), as discussed in GB2156402A. By removing several joints at once in a stand (and not breaking connections between the individual joints in each stand), the total number of threaded connections that are required to be broken may be reduced by 50-67%. However, the number of joints in each stand is limited by the height of the derrick and the pipe rack of the drilling rig, and the method using stands still does not address the time spent breaking the threaded connections that must still be broken.

GB2435059A discloses a device which comprises an extending piston-rod with a bung, which may be selectively engaged within the top of the drillstring to provide a fluid tight seal between the drillstring and top-drive. This arrangement obviates the need for threading and unthreading the drillstring to the top-drive. However, a problem with the device disclosed therein is that the extension of the piston-rod is dependent upon the pressure and flow of the drilling mud through the top-drive. Whilst this may be advantageous in certain applications, a greater degree of control over the piston-rod extension independent of the drilling mud pressure is desirable.

Similarly, there may be applications where it is desirable to displace fluid from the borehole, particularly, for example, when lowering the drillstring (or a casing-string) in deepwater drilling applications. In such deepwater applications, the seabed accommodates equipment to support the construction of the well and the casing used to line the wellbore may be hung and placed from the seabed. In such a configuration, a drillstring (from the surface vessel) may be used as the mechanism to convey and land the casing string into position. As the drillstring is lowered, successive sections of drillstring would need to be added to lower the drillstring (and attached casing string) further. However, as the bore of the typical drillstring is much smaller than the bore of a typical string of casing, fluid displaced by the casing string will flow up and exit through the smaller-bore drillstring, at increased pressure and flow rates. As such, designs such as those disclosed in GB2435059A would not allow reverse flow of drilling mud (or seawater) as would be required in such a casing installation operation.

Embodiments of the present disclosure seek to address these and other issues of the prior art.

### SUMMARY OF THE CLAIMED SUBJECT MATTER

In one aspect, embodiments disclosed herein relate to a hydraulic connector to direct fluids between a lifting assembly and a bore of a downhole tubular including an engagement assembly configured to selectively extend and retract a seal assembly disposed at a distal end of the hydraulic connector into and from a proximal end of the downhole tubular and a valve assembly operable between an open position and a closed position, wherein the valve assembly is configured to allow the fluids to communicate between the lifting assembly and the downhole tubular through the seal assembly when in the open position, and wherein the valve assembly is configured to prevent fluid communication between the lifting assembly and the downhole tubular when closed position, and a one-way valve to allow fluid communication from the downhole tubular to the lifting assembly.

In another aspect, embodiments disclosed herein relate to a hydraulic connector to direct fluids between a first tubular and a second tubular including a piston-rod assembly configured to selectively extend and retract a seal assembly disposed at a distal end of the piston-rod assembly into and from a proximal end of the second tubular and a valve assembly operable between an open position and a closed position, wherein the valve assembly is configured to allow the fluids to communicate between the first tubular and the second tubular through the seal assembly when in the open position, and wherein the valve assembly is configured to prevent fluid communication between the first tubular and the second tubular when closed position.

In another aspect, embodiments disclosed herein relate to a method to connect a lifting assembly with a downhole tubular including disposing a seal assembly upon a distal end of a piston-rod assembly, increasing a pressure of fluids in the lifting assembly, extending the piston-rod assembly, engaging the seal assembly within a proximal end of the downhole tubular, opening a valve of the piston-rod assembly, and hydraulically communicating fluids between the lifting assembly and the downhole tubular.

### BRIEF DESCRIPTION OF DRAWINGS

Features of the present disclosure will become more apparent from the following description in conjunction with the accompanying drawings.

FIGS. 1a and 1b schematically depict a connector in accordance with embodiments of the present disclosure and depicts the connector in position between a top-drive and a downhole tubular.

FIG. 2 is a sectional side projection of the connector in accordance with embodiments disclosed herein and shows the connector prior to engagement with the string of downhole tubulars.

FIG. 3 is a sectional side projection of the connector of FIG. 2 in an engaged position.

FIGS. 4a and 4b are more detailed sectional view of the connector of FIGS. 2 and 3 showing the connector in position to transfer drilling mud to the string of downhole tubulars with the first valve in a closed position (FIG. 4a) and the connector receiving back-flow with the first valve in an open position (FIG. 4b).

FIGS. 5a and 5b are more detailed sectional views of a sealing assembly of the connector according to embodiments of the present disclosure.

FIG. 6a is a side view of an alternative connector in accordance with embodiments disclosed herein and FIG. 6b is a sectional side view of section A-A shown in FIG. 6a.

FIGS. 7a and 7b are a more detailed sectional view of the connector of FIGS. 6a and 6b showing a poppet valve in a closed position (FIG. 7a) and an open position (FIG. 7b).

### DETAILED DESCRIPTION

Select embodiments describe a tool to direct fluids from a top-drive (or other lifting) assembly and a bore of a downhole tubular. In particular, the tool may include an engagement assembly to extend a seal assembly into the bore of the downhole tubular, a valve assembly to selectively allow pressurized fluids from the top-drive assembly to enter the downhole tubular, and a reverse flow valve assembly to selectively allow pressurized fluids from the downhole tubular to flow toward the top-drive assembly within the tool.

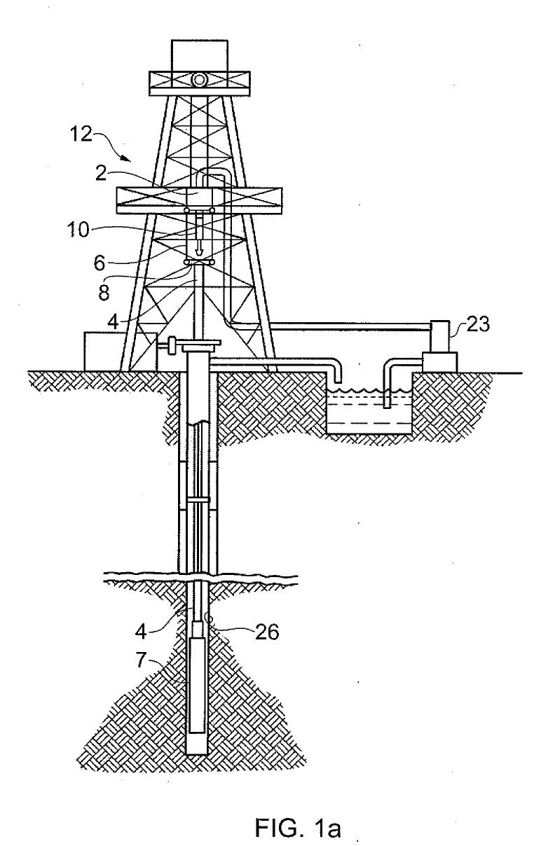

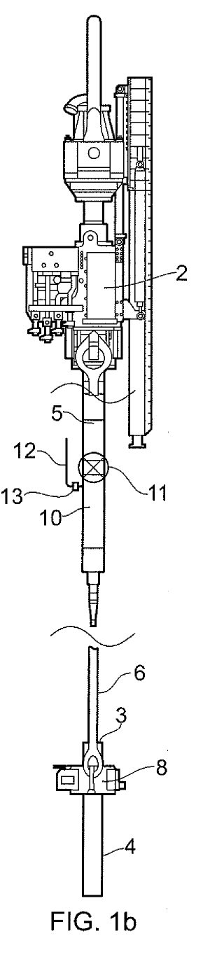

Referring initially to FIGS. 1a and 1b (collectively referred to as “FIG. 1”), a top-drive assembly 2 is shown connected to a proximal end of a string of downhole tubulars 4. As shown, top-drive 2 may be capable of raising (“tripping out”) or lowering (“tripping in”) downhole tubulars 4 through a pair of lifting bales 6, each connected between lifting ears of top-drive 2, and lifting ears of a set of elevators 8. When closed (as shown), elevators 8 grip downhole tubulars 4 and prevent the string from sliding Her into a wellbore 26 (below).

Thus, the movement of string of downhole tubulars 4 relative to the wellbore 26 may be restricted to the upward or downward movement of top-drive 2. While top-drive 2 (as shown) must supply any upward force to lift downhole tubular 4, downward force is sufficiently supplied by the accumulated weight of the entire free-hanging string of downhole tubulars 4, offset by their accumulated buoyancy forces of the downhole tubulars 4 in the fluids contained within the wellbore 26. Thus, as shown, the top-drive assembly 2, lifting bales 6, and elevators 8 must be capable of lifting (and holding) the entire free weight of the string of downhole tubulars 4.

As shown, string of downhole tubulars 4 may be constructed as a string of threadably connected drill pipes (e.g., a drillstring 4), may be a string of threadably connected casing segments (e.g., a casing string 7), or any other length of generally tubular (or cylindrical) members to be suspended from a rig derrick 12. In a conventional drillstring or casing string, the uppermost section (i.e., the “top” joint) of the string of downhole tubulars 4 may include a female-threaded “box” connection 3. In some applications, the uppermost box connection 3 is configured to engage a corresponding male-threaded (“pin”) connector 5 at a distal end of the top-drive assembly 2 so that drilling-mud or any other fluid (e.g., cement, fracturing fluid, water, etc.) may be pumped through top-drive 2 to bore of downhole tubulars 4. As the downhole tubular 4 is lowered into a well, the uppermost section of downhole tubular 4 must be disconnected from top-drive 2 before a next joint of string of downhole tubulars 4 may be threadably added.

As would be understood by those having ordinary skill, the process by which threaded connections between top-drive 2 and downhole tubular 4 are broken and/or made-up may be time consuming, especially in the context of lowering an entire string (i.e., several hundred joints) of downhole tubulars 4, section-by-section, to a location below the seabed in a deepwater drilling operation. The present disclosure therefore relates to alternative apparatus and methods to establish the connection between the top-drive assembly 2 and the string of downhole tubulars 4 being engaged or withdrawn to and from the wellbore. Embodiments disclosed herein enable the fluid connection between the top-drive 2 (in communication with a mud pump 23 and the string of downhole tubulars 4 to be made using a hydraulic connector tool 10 located between top-drive assembly 2 and the top joint of string of downhole tubulars 4.

However, it should be understood that while a top-drive assembly 2 is shown in conjunction with hydraulic connector 10, in certain embodiments, other types of “lifting assemblies” may be used with hydraulic connector 10 instead. For example, when “running” casing or drill pipe (i.e., downhole tubulars 4) on drilling rigs (e.g., 12) not equipped with a top-drive assembly 2, hydraulic connector 10, elevator 8, and lifting bales 6 may be connected directly to a hook or other lifting mechanism to raise and/or lower the string of downhole tubulars 4 while hydraulically connected to a pressurized fluid source (e.g., a mud pump, a rotating swivel, an IBOP, a TIW valve, an upper length of tubular, etc.). Further still, while some drilling rigs may be equipped with a top-drive assembly 2, the lifting capacity of the lifting ears (or other components) of the top-drive 2 may be insufficient to lift the entire length of string of downhole tubular 4. In particular, for extremely long or heavy-walled tubulars 4, the hook and lifting block of the drilling rig may offer significantly more lifting capacity than the top-drive assembly 4.

Therefore, throughout the present disclosure, where connections between hydraulic connector 10 and top-drive assembly 2 are described, various alternative connections between the hydraulic connector and other, non-top-drive lifting (and fluid communication) components are contemplated as well. Similarly, throughout the present disclosure, where fluid connections between hydraulic connector 10 and top-drive assembly 2 are described, various fluid and/or lifting arrangements are contemplated as well. In particular, while fluids may not physically flow through a particular lifting assembly lifting hydraulic connector 10 and into tubular, fluids may flow through a conduit (e.g., hose, flex-line, pipe, etc) used alongside and in conjunction with the lifting assembly and into hydraulic connector 10.

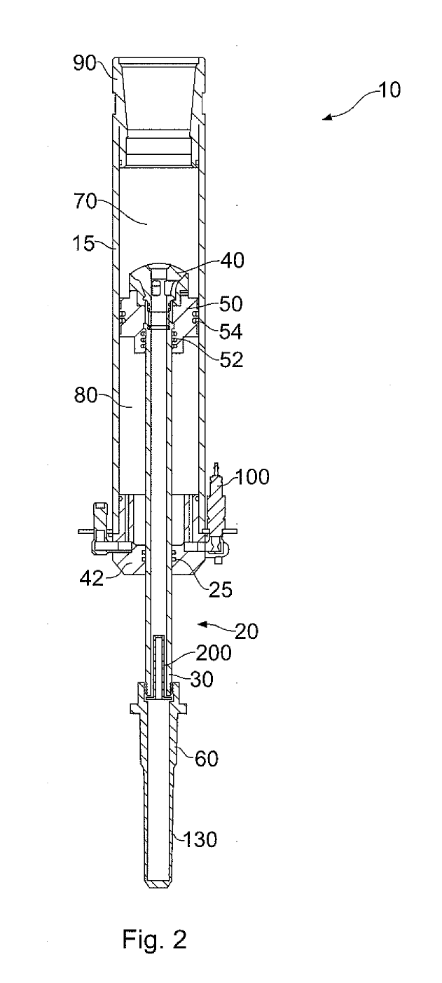

With reference to FIG. 2, a hydraulic connector 10, according to a first embodiment of the disclosure, comprises a cylinder 15 and a piston-rod assembly 20, the piston-rod assembly 20 being slidably engaged in the cylinder 15. The piston-rod assembly 20 may further comprise a hollow tubular rod 30, on which is mounted a cap 40, the tubular rod 30 being slidably engaged in the cylinder 15 such that a first end (i.e., a lower end) of the tubular rod 30 protrudes outside the cylinder 15 and a second end (i.e., an upper end) is within the cylinder 15. The cap 40 is shown mounted on the second, upper, end of the tubular rod 30, whilst on a first end of the tubular rod 30 there is located a bung 60 with seals (e.g., cup seals) 130. The bung 60 may be made from an appropriate sealing material, including, but not limited to, nylon, rubber, or any other appropriate polymer or elastomer, and may be shaped to fit into the top end (typically a box end) of the string of downhole tubulars 4.

A tubular filter 200 may be disposed between the first end of the tubular rod 30 and the bung 60. The filter 200 may be substantially cylindrical with a closed end and an open end between its side-walls. The open end of the filter 200 may comprise an outer-flanged portion about its circumference, which may abut the first end of the tubular rod 30. As shown, the bung 60 threadably engages an outer portion of the first end of the tubular rod 30 and an abutment shoulder within bung 60 abuts the flanged portion of the filter 200 to secure it between the tubular rod 30 and bung 60. In this manner the bung 60 and filter 200 may easily be disconnected from the lower end of tubular rod 30 for replacement, inspection, and/or cleaning.

As shown, filter 200 is arranged with its open end facing (downward) toward bung 60 and the closed end (upward) facing cap 40. Thus, filter 200 may be contained primarily within tubular rod 30 so that flow from the string of downhole tubulars 4 to the hydraulic connector 10 flows will first enter the open end of filter 200, then encounter the side-walls, and finally the closed end of the filter 200. The filter 200 may be sized so that a sufficient gap is provided between the side-walls of the filter and the tubular rod 30, whilst maintaining a sufficient internal diameter of the filter. The dimensions of the filter 200 (e.g., diameter, length, etc.) relative to the tubular rod 30 may be selected so as to reduce the pressure drop across the filter. In certain embodiments, filter 200 may comprise a perforated pipe having a perforated closed end. In alternative embodiments filter 200 may comprise a wire mesh. In still further alternative embodiments, filter 200 may comprise a non-perforated closed end. or any other conventional filter arrangement known to those having ordinary skill.

The tubular rod 30, cylinder 15, bung 60 and cap 40 shown in FIG. 2 are arranged such that their longitudinal axes are coincident. At the lower end of the cylinder 15, beyond which the tubular rod 30 protrudes, there is mounted an end-cap 42. The end-cap 42 seals the inside of the cylinder 15 from the outside, whilst also allowing the tubular rod 30 to slide (i.e., reciprocate) in or out of the cylinder 15. Seals 25 (e.g., o-rings) may be used to seal between the end-cap 42 and tubular rod 30.

As shown in FIG. 2, hydraulic connector 10 further includes a piston 50 slidably mounted on tubular rod 30 inside cylinder 15. As shown, piston 50 is free to reciprocate between the cap 40 and the end-cap 42. Additionally, in certain embodiments, piston 50 may also be capable of rotating about its center axis with respect to cylinder 15. Furthermore, the entire assembly (20, 40, 50 and 60) may be able to slide (and/or rotate) with respect to cylinder 15. As such, the inside of the cylinder 15 may be divided by the piston 50 into a first (lower) chamber 80 and a second (upper) chamber 70. When viewed in a downward direction from above (e.g., from the top-drive), the projected area of the piston 50 may be less than the projected area of the cap 40 such that when the piston 50 abuts the cap 40, the pressure force from the fluid in the second chamber 70 acting on the cap 40 is greater than that acting on the piston 50.

In certain embodiments, the first and second chambers 80 and 70 may be energized with air and drilling mud respectively. Alternatively, any appropriate actuation fluid, including, but not limited to, air, nitrogen, water, drilling mud, and hydraulic fluid, may be used to energize lower chamber 80. The piston 50 may be sealed against the tubular rod 30 and cylinder 15, for example, by means of o-ring seals 52 and 54, to prevent fluid communication between the two chambers 70 and 80. First chamber 80 may be in fluid communication with an air supply via a port 100, which may selectively pressurize first chamber 80. Second chamber 70 may be provided with drilling mud from the top-drive 2 via a socket 90, which may (as shown) be a box component of a rotary box-pin threaded connection. Top-drive 2 may be connected to the hydraulic connector 10 via the engagement of a cooperating (e.g., a pin component of a rotary box-pin) threaded connection (not shown).

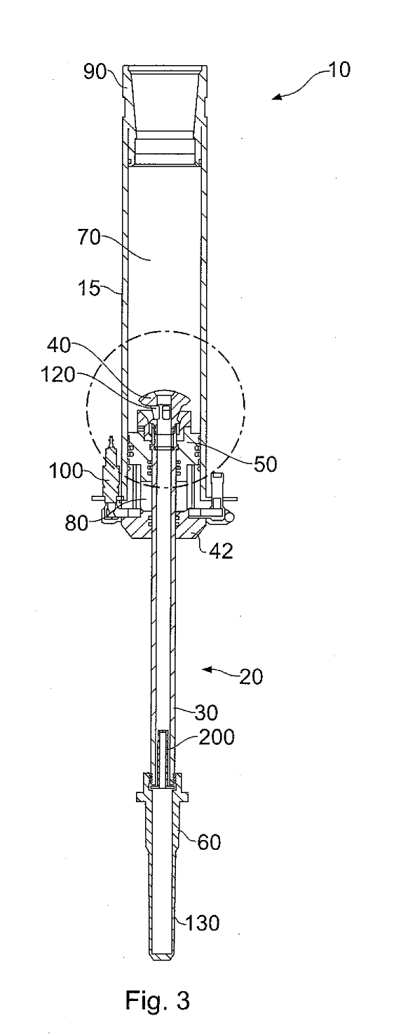

As shown in FIG. 2, the piston 50 and cap 40 are touching so that drilling mud cannot flow from the second chamber 70 to the string of downhole tubulars 4. FIG. 3 shows an alternative position of the cap 40 with respect to piston 50. As shown in FIG. 3, with the cap 40 and piston 50 apart, holes 120 are exposed in the side of the cap 40. These holes 120 provide a fluid communication path between the second chamber 70 and the interior of the tubular rod 30. Thus drilling mud may flow from the second chamber 70 to the string of downhole tubulars 4, via the holes 120 in the cap 40 and the tubular rod 30 when cap 40 is displaced above piston 50.

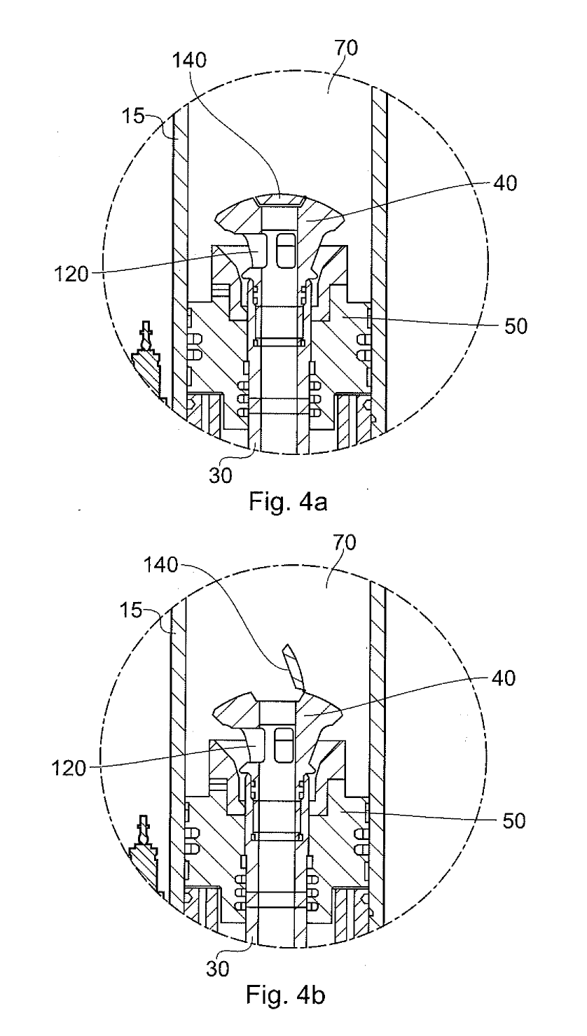

FIGS. 4a and 4b show further detail of the structure of the cap 40 and piston 50. In particular, the flow communication path between the second chamber 70 and the tubular rod 30, via the holes 120, is further highlighted.

Also shown in FIGS. 4a and 4b a valve 140 may be located on the cap 40. As shown, valve 140 may be a one-way flapper valve, which may pivot with respect to the cap 40 by virtue of a hinge. While a flapper valve is depicted for valve 140, it should be understood that any other type of one-way “check” valve may be used without departing from the scope of the present disclosure. As shown in an open position (FIG. 4b), the valve 140 provides a flow path from the bore of tubular rod 30 to the second chamber 70. When valve 140 is in a closed position, this flow path may be blocked. Valve 140 may close when the pressure of the fluid in the second chamber 70 exceeds the pressure of the fluid in the bore of tubular rod 30. Similarly, valve 140 may open if the pressure of fluids in the bore of tubular rod 30 exceeds the pressure of fluids in second chamber 70. In certain embodiments, the flapper of valve 140 may be plug shaped and may have tapered side-walls so that a pressure seal may be formed between the flapper of valve 140 and cap 40 when the pressure in the second chamber 70 exceeds that in the bore of tubular rod 30. In certain embodiments, the flapper of valve 140 may be spring biased into the closed position.

As such, as shown in FIGS. 2-4b, holes 120 of cap 40 may permit fluid to flow between second chamber 70 and bore of tubular rod 30 in both directions when cap 40 is displaced away from piston 50, but flapper of valve 140 may only allow “reverse” flow of fluids from the bore of tubular rod 30 to second chamber 70 when pressure in the bore of tubular rod 30 exceeds pressure in second cylinder 70 by a specified amount. The specified amount (of differential pressure) may be affected by various design considerations, including, but not limited to, the size and mass of flapper of valve 140, and the spring constant of any spring biasing flapper of valve 140 into the closed position.

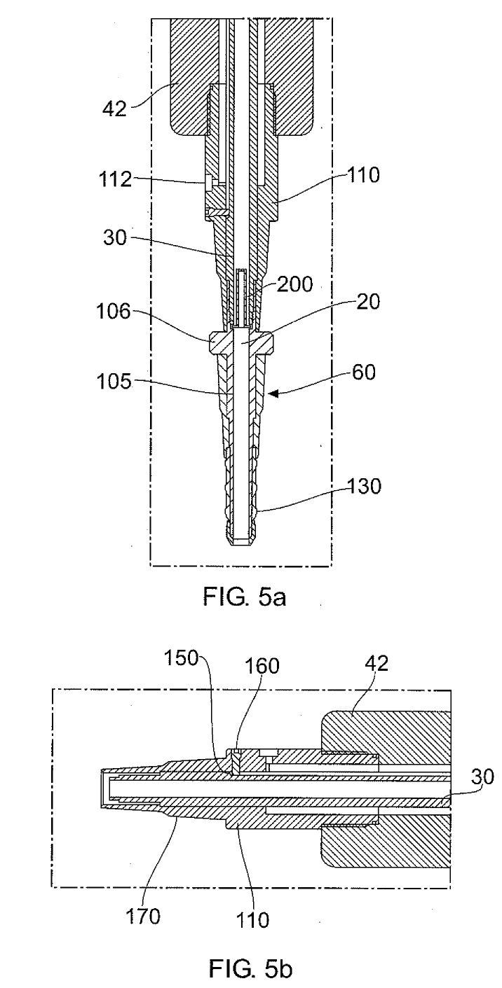

With reference to FIG. 5a, the bung 60, may comprise a detachable shaft 105. Detachable shaft 105 may be threadably attached to tubular rod 30 and may therefore be selectively detachable from tubular rod 30. Additionally, seals 130 may be provided around an outer profile of detachable shaft 105. Detachable shaft 105 may be hollow to accommodate fluids flowing from top-drive assembly 2, through shaft 16, through tubular rod 30, and into downhole tubular 4.

In certain embodiments, detachable shaft 105 and attached seals 130 may be interchangeable with alternative shaft and seal configurations. In select embodiments, interchangeable configurations may facilitate repair and replacement of worn seals 130.

Further, interchangeable configurations may allow for bungs 60 of different shapes and configurations to be deployed for different configurations of downhole tubulars (e.g., 4 of FIG. 1). Furthermore, in certain embodiments, a connection between tubular rod 30 and detachable shaft 105 may be constructed to act as a sacrificial connection. In such embodiments, if an impact load is applied to bung 60, the connection may fail, so that piston-rod assembly 20, cylinder 15, and remainder of hydraulic connector 10 may be protected from damage. For example, detachable shaft 105 may be provided with a female-threaded socket configured to engage a corresponding male thread of tubular rod 30. As such, the female thread of detachable shaft 105 may be deliberately weakened, for example, at its root, so that it may fail before damage occurs to tubular rod 30. Filter 200 may be located between an abutment shoulder in the female threaded socket of the detachable shaft 105 and the male thread on the tubular rod 30.

In select embodiments, the end of the detachable shaft 105 attached to tubular rod 30, may have similar (or smaller) external dimensions as tubular rod 30 to ensure that detachable shaft 105 may fit inside a threaded member 110 that (in certain embodiments) may optionally be threaded to the end of end-cap 42. Threaded member 110 may be connected to the first end cap 42 by virtue of a threaded connection and the threaded member 110 is hollow to allow the tubular rod 30 to pass through it. The threaded member 110 may seal the inside of cylinder 15 from the outside, whilst also allowing the tubular rod 30 to slide in or out of the cylinder 15. In another alternative embodiment, the threaded member 110 and end-cap 42 may be integral and comprise a single component.

The end of the detachable shaft 105, which attaches to the tubular rod 30, has the same or smaller external dimensions as the tubular rod 30. This ensures that the detachable shaft 105 fits inside the threaded member 110. Furthermore, the detachable shaft 105 has a protrusion 106, which acts as a mechanical stop limiting the retraction of the piston-rod assembly 20 into the cylinder 15. The protrusion 106 is shaped with spanner flats so that the detachable shaft 105 can be removed from the tubular rod 30.

Referring now to FIG. 5b, tubular rod 30 is shown further including an abutment shoulder 150. In certain embodiments, abutment shoulder 150 may be formed as a flat portion on the outer surface of tubular rod 30 adjacent to a cylindrical portion. Abutment shoulder 150 may provide a keyway configured to receive a corresponding key 160 of threaded member 110. Key 160 may engage the keyway of abutment shoulder 150 so that rotation of the tubular rod 30 relative to threaded member 110 is prevented, thereby facilitating removal of detachable shaft 105. Furthermore, tubular rod 30 may be fully retracted within threaded member 110 when detachable shaft 105 is removed, such that tubular rod 30 does not extend beyond the end of threaded member 110. Key 160 and keyway may also mechanically limit the retraction of the piston-rod assembly 20 when detachable shaft 105 is removed.

Additionally, threaded member 110 may optionally include a threaded section 170. In select embodiments, threaded section 170 may threadably connect to an open end of downhole tubular 4 so that hydraulic connector 10 may transmit torque from top-drive assembly 2 to downhole tubular 4. Accordingly, in order to transmit torque, threaded connections between top-drive assembly 2, threaded connection 25, threaded member 110, and downhole tubular 4 should be selected that the make-up and break-out directions are the same.

Additionally, for threaded members 110 comprising threaded section 170, a “protector” cap may be provided to protect threads 170 when not in use. Such a protector cap may be constructed of any plastic or elastomeric material known those having ordinary skill in oilfield connections, but may, in the alternative, be constructed from a metallic material. Such a protector cap would be constructed as a generally tubular member having threads corresponding to threads 170 at a proximal end and an open end (through which components of piston-rod assembly 20 may pass) at a distal end. Optionally, the protector cap may include an elongated tubular portion between the distal and proximal ends to server as a protector for components of piston-rod assembly 20 that may be retracted or otherwise housed within the threaded protector cap.

Detachable shaft 105 (and therefore bung 60) may be removed from the tubular rod 30 when threaded member 110 is connected (directly) to downhole tubular 4. Tubular rod 30 may be sized so that it fits inside the interior of downhole tubular 4 beyond a threaded portion of an open end of downhole tubular 4. Alternatively, tubular rod 30 may be retracted into threaded member 110.

In an alternative embodiment, detachable shaft 105 need not be removed from tubular rod 30 when threaded member 110 is attached directly to downhole tubular 4. Hydraulic connector 10 may be connected to downhole tubular 4 by both bung 60 and threaded member 110. As such, the alternative embodiment may allow rapid connection of hydraulic connector 10 between a downhole tubular 4 and a top-drive assembly 2 without having to remove the detachable shaft 105, thereby saving time and money. To engage threaded member 110 with downhole tubular 4 without removing detachable shaft 105, protrusion 106 may be constructed smaller than shown in FIG. 3a so that it does not radially extend beyond the outer surface of bung 60.

Additionally, threaded member 110 may be removable from first end cap 42 and may therefore be interchangeable with alternative threaded members. This interchangeability may facilitate repair of the threaded member 110 and may also enable differently-shaped threaded members (110) to be configured for use with a particular downhole tubular 4.

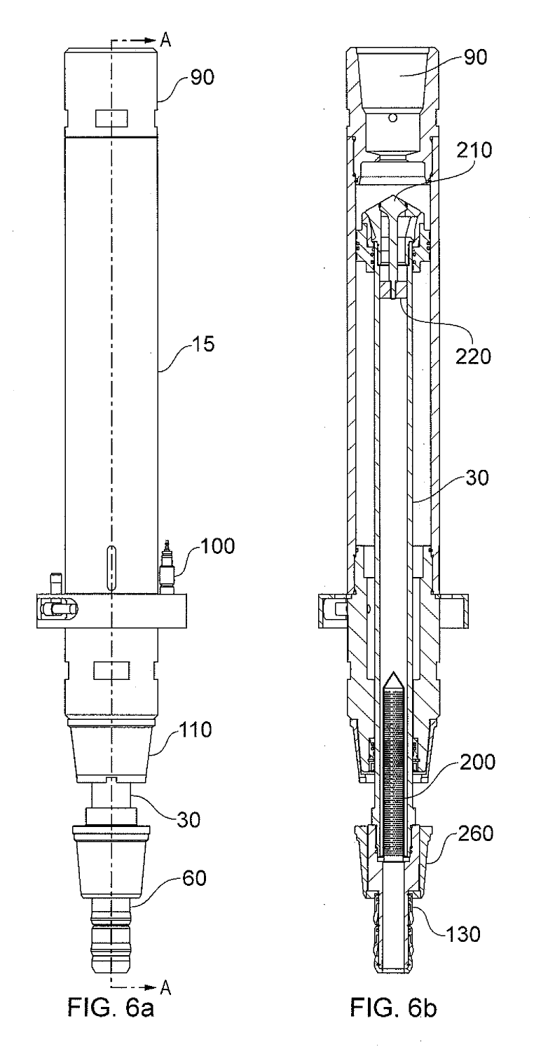

With reference to FIGS. 6a and 6b, a hydraulic connector 10, according to an alternative embodiment of the disclosure, is shown comprising a poppet valve 210. The poppet valve 210 is a one-way flow valve and may be used in place of the flapper valve 140 of the embodiment shown in FIGS. 4a and 4b. The hydraulic connector 10, according to this alternative embodiment may also comprise an additional cup seal 260 on bung 60 to facilitates improved engagement with the top end of the string of downhole tubulars 4. However, those having ordinary skill in the art will appreciate that cup seals should not be limited to the embodiment shown in FIGS. 6a and 6b, in that cup seals may be applicable to the embodiments shown in FIGS. 2-4b as well.

Additionally, filter 200 of this alternative embodiment may also comprise a conical section at the closed end of the filter 200 facing the cap 40. The conical section on the filter 200 may assist in directing the flow from the hydraulic connector 10 to the string of downhole tubulars 4 and may also improve the ability of the filter 200 to self-clean.

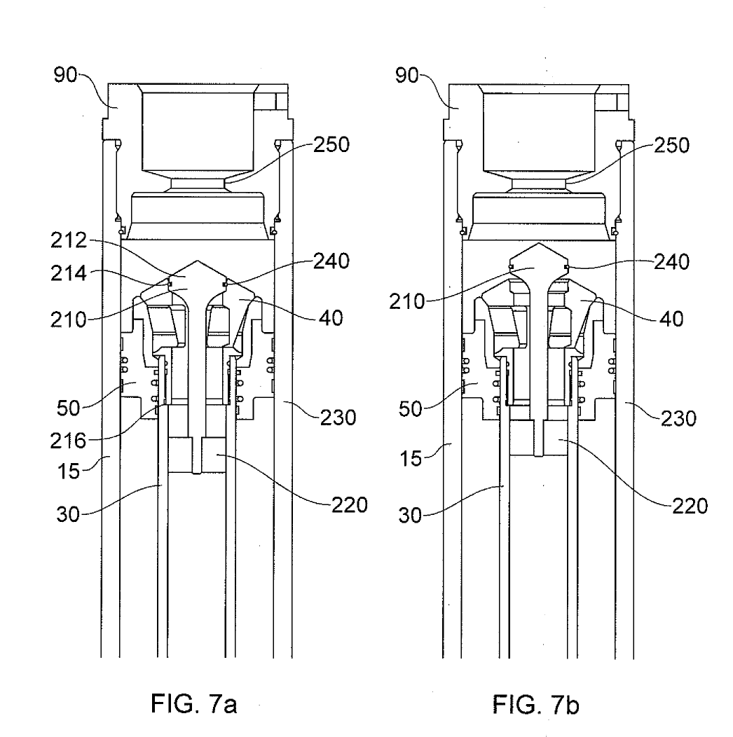

FIGS. 7a and 7b depict the poppet valve 210 at the upper end of hydraulic connector 10 in more detail. FIG. 7a shows poppet valve 210 in a closed position and FIG. 7b shows poppet valve 210 in an open position. As shown, poppet valve 210 comprises a seat portion 214 on the cap 40 and a corresponding poppet head 212. A seal 240 is provided on the poppet head 212 to ensure a fluid tight seal between the poppet head 212 and poppet seat 214 when poppet valve 210 is in the closed position. In select embodiments, the socket 90 may also comprise a shoulder 250 to abut the poppet head 212 when the piston-rod assembly 20 is in a fully retracted position.

The poppet valve 210 further comprises a weighted member 220 which may be attached to the poppet head 212 via a poppet stem 230. The weighted portion 230 may comprise one or more ports (not shown) to allow the free passage of fluid through the tubular rod 30. The ports may be shaped so as to minimize the pressure drop across the weighted portion 230. The weighted portion 230 may also serve to guide the motion of the poppet valve 210 in the tubular rod 30. As such, weighted portion 230 may slide in the tubular rod 30 and the motion of the weighted portion 230 (and therefore poppet valve 210) may be limited (in the upward direction) by an abutment shoulder 216 in the tubular rod 30. Furthermore, the weighted portion 230, by virtue of gravity, biases the poppet valve 210 into a closed position. Alternatively, the poppet valve 210 may be spring biased.

Operation of the hydraulic connector 10 according to the embodiments disclosed herein will now be described. To extend the piston rod 30, so that the bung 60 and seal 130 engage the string of downhole tubulars 4, the pressure of the drilling mud in the second chamber 70 of the connector may be increased by allowing flow from the top-drive 2. The air in the first chamber 80 may be set at a pressure sufficiently high to ensure that the piston 50 abuts the cap 40. As the pressure of the drilling mud increases, the force exerted by the drilling mud on the piston 50 and cap 40 exceeds the force exerted by the air in the first chamber on the piston 50 and the air outside the hydraulic connector 10 acting on the piston-rod assembly 20. The cap 40 is then forced toward the end-cap 42 and the piston-rod assembly 20 extends. As the projected area of the cap 40 is greater than the projected area of the piston 50 and the air pressure in the first chamber 80 is only exposed to the piston 50, the piston 50 may remain abutted against cap 40. Thus, whilst the piston-rod assembly 20 is extending, the holes 120 are not exposed and drilling mud cannot flow from the top-drive 2 into the string of downhole tubulars 4. Furthermore, as the pressure of the drilling mud in the second chamber 70 exceeds the pressure of the air within the tubular rod 30, the valve 140 may also remain closed.

Once the bung 60 and seals 130 are forced into the open threaded end of the upper end of the string of downhole tubulars 4, thereby forming a fluid tight seal between the piston-rod assembly 20 and the open end of the drill string 4, the piston-rod assembly 20, and hence cap 40, are no longer able to extend. In contrast, as the piston 50 is free to move on the tubular rod 30, the piston 50 is forced further along by the pressure of the drilling mud in the second chamber 70. The holes 120 are thus exposed and drilling mud is allowed to flow from the second chamber 70, through the piston-rod assembly 20 and into the string of downhole tubulars 4. With the holes 120 open, the hydraulic connector 10 will ensure that the volume displaced by the removal of the string of downhole tubulars 4 from the well is replaced by drilling mud. The pressure of the air in the first chamber 80 may then be released until retraction of the piston-rod assembly 20 is required.

If the piston-rod assembly 20 extends fully from cylinder 15 before bung 60 and seals 130 fully engage string of downhole tubulars 4, the piston 50 will be prevented from lowering further by the end-cap 42. The holes 120 will therefore be unable to open and this ensures that no drilling mud is spilt if the piston-rod assembly 20 does not fully engage a string of downhole tubulars 4.

Alternatively, if the string of downhole tubulars 4 is to be lowered into the well while attached to the hydraulic connector 10, then the string of downhole tubulars 4 will displace fluid within the well and result in a back-flow into the hydraulic connector 10 and top-drive 2. Under such circumstances, or if there is sufficient back-flow for any other reason, the valve (flapper valve 140 or poppet valve 210) may open if pressure of the fluid in the tubular rod 30 is greater than the pressure of the drilling fluid in the second chamber 70. Furthermore, as the air pressure in first chamber 80 may be reduced, the piston 50 may be in the open position permitting flow through the holes 120.

However, the presence of reverse valves 140, 210 allow additional reverse flow in the event of a sudden surge in fluid pressure from the string of downhole tubulars 4. In particular, with valve (140 or 210) opened by reverse flow, the pressure drop across the piston-rod assembly 20 may be negligible and the piston-rod assembly 20 may remain engaged with the string of downhole tubulars 4. Without the valve 140, 210, a significant pressure drop may result across the holes 120 and there may be a risk that the piston-rod assembly 20 is forced out of the string of downhole tubulars 4 by this reverse pressure. The valve 140, 210 therefore allows the hydraulic connector 10 to be used in both lowering and removal modes of operation.

Finally, when it is desired to retract the piston-rod assembly 20 from the string of downhole tubulars 4, the pressure of the air in the first chamber 80 may be increased. The top-drive's drilling mud pumps may also be stopped to reduce the pressure of the drilling mud in the second chamber 70. The force exerted on the piston 50 by the drilling mud may then be less than the force exerted on the piston 50 by the air so that the piston 50 is biased towards the cap 40 and socket 90. The upward movement of piston 50 retracts the piston-rod assembly 20 into the cylinder 15 and out of string of downhole tubulars 4. Additionally, the upward movement of piston 50 results in abutment of the cap 40 therewith, thereby closing the holes 120 and preventing mud from flowing out of the hydraulic connector 10. Furthermore, the movement of the cap 40 may cause the valve 140 to close and the resulting increase in pressure in the second chamber 70 may ensure that the valve 140, 210 is sealed and that no drilling mud leaks from the retracting piston-rod assembly 20. With the piston-rod assembly 20 is retracted, the bung 60 and the seals 130 are retracted from the string of downhole tubulars 4 and the top most section of the string of downhole tubulars 4 may be removed.

During back-flow, when drilling fluid flows from the string of downhole tubulars 4 to the top-drive 2, the filter 200 may filter out any debris and particulate matter, thereby protecting various components of the hydraulic connector 10 and the top-drive 2. The (upward) orientation of the filter 200 encourages any debris to collect at the closed (i.e., uppermost) end of the filter. Thus, when the flow is reversed such that drilling fluid flows from the top-drive 2 to the string of downhole tubulars 4, the debris that has collected at the closed end of the filter is flushed back into the well-bore. The filter 200 may therefore exhibit a self-cleaning function as a result of its orientation. By contrast, if the filter 200 were orientated with the closed end facing the string of downhole tubulars 4, debris would collect about the flange of the filter during back-flow. Reversal of the flow (i.e., toward the string of downhole tubulars 4) would then not be as effective at removing the debris from around the flange. The accumulation of debris may result in an increase in the pressure drop across the filter.

As described above, the hydraulic connector 10 may replace the traditional threaded connection between a top-drive 2 and string of downhole tubulars 4 during the removal or lowering of a string of downhole tubulars 4 from or into a well. Advantageously, the hydraulic connector permits a hydraulic connection between the top-drive 2 and the string of downhole tubulars 4 during tripping operations. As such, the hydraulic connector 10 may be used to more rapidly sealingly engage and disengage the string of downhole tubulars 4 without risk of damaging the threaded portions of either the top-drive 2 or the string of downhole tubulars 4.

Advantageously, embodiments disclosed herein discloses a hydraulic connector which provides a fluid tight connection between a fluid supply and a downhole tubular, the connector comprising a body portion and an extendable portion, the extendable portion having a seal at or towards its free end which is adapted to sealingly engage the downhole tubular, the extendable portion comprising a pressure face exposed to a fluid in the body portion, so that the extendable portion extends from the body portion by virtue of the fluid pressure of the fluid in the body portion acting on the pressure face, the connector also comprising a first valve provided on the extendable portion, the first valve being a one-way flow valve permitting flow from the downhole tubular in to the connector.

The connector may also comprise a second valve, which may selectively permit flow from the connector to the downhole tubular. The second valve may be arranged such that it may be opened by the pressure of fluid from the fluid supply when the seal is engaged in the downhole tubular. The second valve may be arranged such that it may be opened by the pressure of fluid from the fluid supply only when the seal is engaged in the downhole tubular. The second valve may be provided. in a parallel arrangement with the first valve between the downhole tubular and the fluid supply.

The extendable portion may extend when the pressure of the fluid in the body portion exceeds a threshold value. The seal between the connector and the downhole tubular may be provided by the location of a tapered bung in the open end of the downhole tubular.

The extendable portion may comprises a shaft and a cap, the shaft may be slidably mounted within the body portion and may extend through an end-cap in the body portion. The cap may be provided on an end of the shaft within the body portion, wherein the pressure face may comprise the cap.

The connector may further comprise a piston. The piston may be slidably mounted on the shaft between the cap and the end-cap. The piston and cap may divide the body portion into first and second chambers. The first chamber may contain a first fluid and the second chamber may contain a second fluid. The first chamber may contain air, which may be selectively compressed. The second chamber may contain drilling-fluid or drilling mud.

The projected area of the cap exposed to the second chamber and the projected area of the piston exposed to the second chamber may be selected so that the pressure force acting on the cap toward the first chamber may be greater than the pressure force acting on the piston when the extendable portion extends. The projected area of the cap exposed to the second chamber may be greater than the projected area of the piston exposed to the second chamber.

The shaft may be hollow and may provide a flow communication path between the second chamber and the downhole tubular. A hole forming part of the flow communication path may be provided in a side-wall of the shaft and the hole may be selectively covered by the piston. The hole and piston arrangement may together form the second valve.

In response to a pressure difference between the fluid in the first and second chambers and/or when the extendable portion is not engaged with the downhole tubular, the piston and cap may move together, with the hole in the side-wall of the shaft covered by the piston. In response to a pressure difference between the fluid in the first and second chambers and/or when the extendable portion is engaged with the downhole tubular, the piston may move independently of the cap, thereby enabling the hole in the side-wall of the shaft to be uncovered.

The first valve may be a flapper valve. The first valve may be provided on the pressure face of the extendable portion. The first valve may be provided on the cap. The first valve may be biased towards a closed position. The first valve may be arranged so that the net pressure force acting on the extendable portion when the first valve is open is not sufficient to move the extendable portion. Opening of first valve reduces the pressure loss between the downhole tubular and the fluid supply, thereby reducing the net pressure force acting on the extendable portion and preventing retraction of the extendable portion from the downhole tubular. The first valve may open when there is a back-flow from the downhole tubular. To receive back-flow, the supply of drilling fluid to the connector from the top-drive may be switched off and the air supply to the first chamber may also be switched off.

The first valve may be a poppet valve. The poppet valve may comprise a poppet and a seat and the seat may be provided on the pressure face. The seat may be provided on the cap. The poppet valve may further comprise a weighted portion which may be connected to the poppet via a stem. The weighted portion may slide inside the extendable portion and the weighted portion may be provided with ports for the free flow of fluid through the extendable portion.

The seal may sealingly engage the downhole tubular when the extendable portion is at least partially extended from the body portion. The downhole tubular may be a component of a drillstring or a casing-string. The extendable portion may be a piston-rod. The body portion may be a cylinder.

The connector may be capable of transmitting torque from a top-drive to the string of downhole tubulars via a threaded portion engaging with the threaded section of the string of downhole tubulars. All threaded connections may be orientated in the same direction. The threaded portion may comprise a standard pin connection. The threaded section in the open end of the string of downhole tubulars may comprise a standard box connection.

Advantageously a method to provide a fluid tight connection between a fluid supply and a downhole tubular using a connector, the connector comprising a body portion and an extendable portion, the extendable portion having a seal at or towards its free end which is adapted to sealingly engage the downhole tubular, the extendable portion comprising a pressure face exposed to a fluid in the body portion, so that the extendable portion extends from the body portion by virtue of the fluid pressure of the fluid in the body portion acting on the pressure face, the connector also comprising a first valve provided on the extendable portion, the first valve being a one-way flow valve permitting flow from the downhole tubular in to the connector. The method may comprise sealingly engaging the seal of the extendable portion with the downhole tubular, permitting flow from the fluid supply to the downhole tubular once the seal is engaged in the downhole tubular, and allowing a reverse flow from the downhole tubular to the fluid supply by virtue of the one-way flow valve, when the pressure in the downhole tubular exceeds that of the fluid supply. The method may further comprise biasing the one-way flow valve to the closed position.

While the disclosure has been presented with respect to a limited number of embodiments, those skilled in the art, having benefit of this disclosure, will appreciate that other embodiments may be devised which do not depart from the scope of the present disclosure. Accordingly, the scope of the disclosure should be limited only by the attached claims.

What is claimed is:

1. A hydraulic connector to direct fluids between a lifting assembly and a bore of a downhole tubular, the hydraulic connector comprising:
an engagement assembly configured to selectively extend and retract a seal assembly disposed at a distal end of the hydraulic connector into and from a proximal end of the downhole tubular;
a valve assembly operable between an open position and a closed position;
wherein the valve assembly is configured to allow the fluids to communicate between the lifting assembly and the downhole tubular through the seal assembly when in the open position;
wherein the valve assembly is configured to prevent fluid communication between the lifting assembly and the downhole tubular when closed position; and
a one-way valve to allow fluid communication from the downhole tubular to the lifting assembly.

2. The hydraulic connector of claim 1, wherein the one-way valve is configured to allow fluid communication from the downhole tubular to the lifting assembly when a pressure of fluids in the downhole tubular exceeds a pressure of fluids in the lifting assembly by a specified amount.

3. The hydraulic connector of claim 1, wherein the one-way valve is configured to allow fluid communication from the downhole tubular to the lifting assembly when the seal assembly is engaged into the downhole tubular.

4. The hydraulic connector of claim 1, wherein the one-way valve comprises a flapper valve.

5. The hydraulic connector of claim 1, wherein the one-way valve comprises a poppet valve.

6. The hydraulic connector of claim 1, wherein the one way valve is spring biased.

7. The hydraulic connector of claim 1, wherein the one way valve is weight biases.

8. The hydraulic connector of claim 1, wherein the wherein the engagement assembly is configured to extend the seal assembly when a pressure of fluids in the lifting assembly exceed a threshold value.

9. The hydraulic connector of claim 1, wherein the valve assembly comprises a piston configured to be displaced away from a cap of the engagement assembly when the seal assembly is engaged in the downhole tubular.

10. The hydraulic connector of claim 1, wherein the engagement assembly comprises a piston configured to divide a cylinder into a first chamber and a second chamber.

11. The hydraulic connector of claim 10, wherein the second chamber is in communication with drilling mud to extend the seal assembly.

12. The hydraulic connector of claim 10, wherein the second chamber is in communication with pressurized air to retract the seal assembly.

13. The hydraulic connector of claim 10, wherein the engagement assembly comprises a hollow shaft extending between the piston and the seal assembly to allow the fluids to communicate between the lifting assembly and the downhole tubular.

14. The hydraulic connector of claim 1, wherein the lifting assembly comprises a top-drive assembly.

15. A hydraulic connector to direct fluids between a first tubular and a second tubular, the hydraulic connector comprising:
a piston-rod assembly configured to selectively extend and retract a seal assembly disposed at a distal end of the piston-rod assembly into and from a proximal end of the second tubular; and
a valve assembly operable between an open position and a closed position;
wherein the valve assembly is configured to allow the fluids to communicate between the first tubular and the second tubular through the seal assembly when in the open position;
wherein the valve assembly is configured to prevent fluid communication between the first tubular and the second tubular when closed position.

16. The hydraulic connector of claim 15, further comprising a one-way valve to allow fluid communication from the second tubular to the first tubular.

17. The hydraulic connector of claim 16, wherein the one-way valve is configured to allow fluid communication from the second tubular to the first tubular when a pressure of fluids in the second tubular exceeds a pressure of fluids in the first tubular by a specified amount.

18. The hydraulic connector of claim 16, wherein the one-way valve is configured to allow fluid communication from the second tubular to the first tubular when the seal assembly is engaged into the second tubular.

19. The hydraulic connector of claim 15, wherein the first tubular comprises a top-drive assembly.

20. The hydraulic connector of claim 15, wherein the second tubular comprises a string of downhole tubulars.

21. A method to connect a lifting assembly with a downhole tubular, the method comprising:
disposing a seal assembly upon a distal end of a piston-rod assembly;
increasing a pressure of fluids in the lifting assembly;
extending the piston-rod assembly;
engaging the seal assembly within a proximal end of the downhole tubular;
opening a valve of the piston-rod assembly; and
hydraulically communicating fluids between the lifting assembly and the downhole tubular.

22. The method of claim 21, further comprising:
opening a one-way valve of the piston-rod assembly when a pressure of fluids in the downhole tubular exceeds a pressure of fluids in the lifting assembly by a selected amount.

23. The method of claim 21, further comprising:
closing the valve of the piston-rod assembly;
reducing the pressure of fluids in the lifting assembly;
increasing a pressure of a retraction fluid in a lower chamber of the piston-rod assembly; and
retracting the seal assembly from the proximal end of the downhole tubular.
